(19) United States
(12) Patent Application Publication
(10) Pub. No.: US 2014/0346417 A1
(43) Pub. Date: Nov. 27, 2014

(54) USE OF A ZINC-OXIDE-CONTAINING FRIT AS A UV PROTECTION MEANS AND PVC PLASTIC HAVING SUCH A FRIT

(71) Applicant: Ley & Co. Farbenwerke Wunsiedel KG, Marktredwitz-Brand (DE)

(72) Inventor: Michael Nürnberger, Marktredwitz-Brand (DE)

(21) Appl. No.: 14/363,790

(22) PCT Filed: Nov. 27, 2012
(86) PCT No.: PCT/EP2012/073746

§ 371 Date: Jun. 6, 2014

(30) Foreign Application Priority Data
Dec. 6, 2011 (DE) 10 2011 120 174.6
Feb. 14, 2012 (DE) 10 2012 004 138.1

(51) Int. Cl. C03C 8/16; C03C 4/08

(52) U.S. Cl. CPC C03C 8/16; C03C 4/085; C03C 2204/00; C03C 2205/00
USPC 252/589; 65/21.5

(57) ABSTRACT

The invention describes the use of a zinc oxide containing frit with a ZnO content of 20 wt % to 75 wt % and an average grain size of less than 30 μm as a UV light absorbing UV protection means, for example for the application areas of thermoplastically deformable synthetic materials, solvent-containing and water-containing lacquers/varnishes, radiation-curing lacquers/varnishes, powder lacquers/varnishes, paper coatings and hydraulic-setting construction products.

The invention relates to the use of a frit containing zinc oxide (ZnO) as a UV protection means (and/or a UV protection pigment), for example an acid-stable and at the same time (photo)catalytically inert UV protection means/pigment, in a carrier material, for example in synthetic material systems and lacquer/varnish systems.

Organic and inorganic UV protection means are currently used, for example for the application in thermoplastic or thermosetting synthetic materials. The UV protection means has the task of protecting, for example, synthetic material surfaces or lacquer/varnish surfaces against decomposition by UV radiation in the wavelength range of 280 nm to 380 nm.

So-called UV absorbers, quenchers and HALS may be considered as organic UV protection means. Hydroxyphenyl benzotriazoles and hydroxybenzophenones are primarily used as UV absorbers. In the field of quenchers, mainly nickel chelates are used. Similarly to UV absorbers, short-wave UV radiation is converted into long-wave, low-energy radiation also in this case. The group of HALS (Hindered Amine Light Stabilizer) systems consists of monomeric, oligomeric and polymeric amine compounds which deactivate radicals arising from UV radiation and hence contribute to an improved UV stability on/at the synthetic material surface or lacquer/varnish surface. The application of organic UV absorbers is disputed due to ineffectiveness and/or is limited to low application concentrations due to the high costs involved.

Inorganic chemistry provides a plurality of UV protection means that can be divided into colored or black UV absorbers and transparent or opaque UV absorbers. In this regard, the group of rutile mixed phase pigments, such as Sb- and Ni-doped titanium oxides, forms part of the colored UV absorbers, while carbon black forms part of the black UV absorbers.

The present invention focuses on the inorganic UV absorbers, for example on the transparent, colorless and opaque inorganic UV absorbers.

Titanium dioxide (TiO₂) is the primary representative of opaque inorganic UV absorbers. TiO₂ is for the most part used as a coated TiO₂ pigment with a rutile structure at present. The TiO₂ coating often consists of a thin inorganic layer containing Si and/or Al, and serves to protect the surrounding matrix against the photocatalytic decomposition which characterizes uncoated TiO₂ with anatase and a rutile structure. Alternatively or in addition, the TiO₂ is doped with zirconium in the core. TiO₂ is an excellent absorber in the UVB wavelength range (315 nm to 280 nm) and still a good absorber in the UVA wavelength range (380 nm to 315 nm). Using TiO₂ has the disadvantage that not 100 per cent of the surfaces of the TiO₂ pigment particles are covered by the coating, and thus a photocatalytically induced radical attack on the surrounding matrix of the TiO₂ particles occurs in the case of UV radiation and a simultaneous influence of moisture. The terms surrounding matrix or binder matrix refer to the environment of the UV absorbers or UV protection pigments to be protected directly. Especially in case of an outdoor application and when exposed to direct sunlight, the TiO₂ surrounding matrix is decomposed due to the photocatalytic effect of the incompletely coated TiO₂, and a microporous, rough surface structure is formed in the binder matrix, which simulates a change in color intensity mainly in the case of dark color hues. The destroyed microporous structure results in a greater scattering of the incident light than would be the case on a smooth surface. The surface appears mat and brightened. This change in color intensity is also referred to as chalking.

Due to its high refractive index of 2.7, TiO₂ is for example used as a UV protection pigment or a UV absorber for light and covering (opaque) synthetic material and lacquer/varnish systems. In the case of dark color hues and the simultaneous existence of the opaque TiO₂ pigment, an unreasonably high color pigment application is required to obtain a strong and color-intensive final color hue. In clear or transparent systems, TiO₂ has an opacifying effect, so that the application of TiO₂ as a UV protection pigment is not suitable in this case.

ZnO may be used as a UV protection pigment/protection means as an alternative to or in combination with TiO₂. ZnO has a better UV absorption than TiO₂, in particular in the UVA wavelength range (380 nm to 315 nm). The main disadvantage of ZnO is its good solubility in acids. In the thermoplastic production and processing (for example in an extruder) of, for example, PVC, HCl vapor is released/created, which reacts with ZnO to ZnCl₂. The ZnCl₂ resulting therefrom is hygroscopic and, which is even more unfavorable, it catalyzes the thermal decomposition of PVC. Pure ZnO also shows a photocatalytic formation of radicals, which is, however, less strong than that of pure rutile. The intensity of the photocatalytic effect—and thus the tendency to chalking—of pure ZnO may rather be compared to that of incompletely coated TiO₂. The refractive index of ZnO is 2.0, so that a synthetic material matrix (refractive index: 1.4 to 1.6) can be over-dyed to a color-intensive dark color system with a relatively limited/small use of color pigments.

Amongst others, the following documents are known from the state of the art: In WO 90/06974, the use of water glass-coated ZnO pigments is described for the application as an acid-proof UV protection for synthetic materials. Here, a silicate-based coating is concerned, which encases the ZnO core material, so that there is an inhomogeneous distribution of ZnO and the silicate-based component.

DE 1 496 646 A describes a finely ground frit containing ZrO₂ and/or TiO₂ for the application field of synthetic materials, which may contain up to 15 wt % of ZnO. It is an object of that invention to keep the opacity or the degree of whiteness high despite the siliceous dilution.

Glass fits having a similar composition are, for example, known from EP 1 870 383 A1, EP 1 298 099 Al, U.S. Pat. No. 5,618,764, and U.S. Pat. No. 4,493,900. However, these known frits have not been used as a UV protection pigment so far.

A frit is understood as molten glass already solidified and ground again, which may have crystalline component parts in addition to amorphous parts. The frit according to the invention may consist of network formers, such as SiO₂ or B₂O₃, network modifiers, such as alkali oxides or alkaline earth oxides, and ZnO and, as the case may be, intermediate oxides, such as Al₂O₃ (which may act both as network modifiers and as network formers). An amorphous glass phase is produced by melting the network formers, network modifiers and intermediate oxides. For a preparation of mat frits, different opacifying agents, such as TiO₂, SnO₂, ZrO₂, CeO₂ and Ca₃(PO₄)₂ and Na₃AlF₆ are used in addition. The opacifying agents are predominantly exposed and are not provided as part of the network of the glass phase in the glass. Oxides or mixed oxides may be crystallized from the amorphous glass phase by an additional tempering step.

The invention aims at providing a cost-effective and efficient/effective UV protection means (for example a UV protection pigment), for example a UV absorber for protecting the surrounding matrix against destructive UV radiation, for example for use in a thermoplastic or thermosetting synthetic material.

For this purpose, the invention suggests the use of a frit containing ZnO as described in claim 1. Further embodiments of the use according to the invention are described in the dependent claims. Claim 12 describes the advantageous use of the frit in PVC, or rather the PVC synthetic material resulting therefrom, in which the frit is distributed.

In this respect, the inventor has found a solution to integrate ZnO as a chemically and mechanically stable UV light absorbing protective means/pigment into a binder matrix of, for example, thermoplastic or thermosetting synthetic material.

Surprisingly, it has been found out that ZnO bound in a frit comprises an excellent UV light absorption and at the same time proves itself to be acid-proof and abrasion-proof as well as photocatalytically inert with respect to the surrounding matrix. In this context, the ZnO is provided in a crystalline form in the frit and/or as a part of the network of the glass phase.

The above-described problem is, for example, solved by a frit that is, in addition to 20 wt % to 75 wt % of ZnO, further composed of:
5 wt % to 85 wt %, for example 5 wt % to 80 wt % of at least one network former from the oxides of the group of SiO₂, B₂O₃ and P₂O₅,
0.05 wt % to 50 wt % of at least one network modifier from the oxides of the group of BaO, CaO, SrO, K₂O, Na₂O and Li₂O,
0 wt % to 50 wt %, for example 5 wt % to 50 wt % of at least one intermediate oxide from the oxides of the group of Al₂O₃, V₂O₅, Fe₂O₃ and MgO, as well as
0 wt % to 50 wt % of one or more opacifying agents from the oxides of the group of TiO₂, SnO₂ and ZrO₂, CeO₂ as well as Ca₃(PO₄)₂ and Na₃AlF₆.

The ZnO concentration in the frit may, for example, be greater than 30 wt %, for example greater than 50 wt %.

The ZnO containing frit incorporated in a thermoplastic or thermosetting synthetic material matrix as a protection means or pigment protects the surrounding matrix by the irradiated high-energy UV light being predominantly absorbed and converted into thermal radiation with a longer wavelength and emitted by the frit containing ZnO. The fraction of the UV light reflected or scattered on the frit containing ZnO is, for example, low, so that there is no additional stress by radiation to the surrounding matrix by reflection or scattering on the frit containing ZnO. The transmission of the UV light is, for example, low as well.

The absorption effect is, on the one hand, achieved by the ZnO in its function as a network modifier interrupting the siliceous framework so strongly that there is a shift of the UV absorption to higher wavelength ranges in comparison to normal borosilicate or soda-lime glasses. In contrast, pure quartz glass, as a representative of an undisturbed siliceous network, has no UV absorption and is therefore to be considered as being UV transparent. On the other hand, ZnO particles undissolved in the glass phase or recrystallized absorb UV light due to the semiconductor property of ZnO.

A potentially occurring scattering of the UV light on/at the crystalline ZnO particles opacifies the frit, but does not contribute to protecting the surrounding matrix.

When being incorporated into PVC, the frit containing ZnO results in a comparatively significantly smaller tendency to chalking than it is, for example, the case with pure ZnO or in comparison to different qualities of coated TiO₂, as well as to BaSO₄ or other fits containing zirconium.

The frit containing ZnO may be produced in accordance with known methods by mixing and melting predominantly oxidic or siliceous raw materials, and by subsequently cooling and grinding the frozen melt. Moreover, an additional tempering process may follow or may be interposed, with the aim to induce a recrystallization of ZnO. An exemplary average/mean crystallite size of the recrystallized or undissolved ZnO particles in the frit is, for example, less than 300 nm, for example less than 100 nm. The resulting mean/average grain size of the frit after grinding, in relation to the particle number, should be less than 30 μm, for example less than 5 μm, and for example less than 1 μm. The burning temperature during the melting process may be between 600° C. and 1,400° C., for example between 900° C. and 1,200° C. The optional tempering occurs, for example, at temperatures of 400° C. to 900° C.

For preparing the frit, ZnO qualities are, for example, used, which include a maximum of 1 wt % of impurities and have a sieve retention of less than 0.05 wt % with a mesh size of 42 μm. The qualities are, amongst others, also known from the product names “red seal”, “green seal”, and “white seal”. Other raw material used are, for example, commercially available oxides, silicates, borates, carbonates or fluorides, such as feldspars, quartz powder, kaolin, zirconium silicate, rutile, calcspar, barium carbonate, bone ashes, cryolite or fluorite, etc. The use as a powder with a mean grain size of less than 100 μm may be mentioned as an example.

The color of the frit is, for example, white or colorless, depending on the system in which the observation takes place. When exposed to air, the color is, for example, white, a degree of whiteness of more than 90% being aimed for in the CieL*a*b measuring system. Both the a value (yellow blue axis) and the b value (green red axis) are, for example, between −4 and +4 points.

If the frit is, for example, incorporated into the synthetic material PVC, the degree of whiteness strongly decreases when compared to the observation when exposed to air, and the total system of PVC and the frit containing ZnO appears almost transparent. This is caused by the refractive indices of PVC and the frit containing ZnO. The refractive index of the frit containing ZnO lies between 1.4 and 2.6, for example between 1.5 and 2.0. The synthetic material matrix or lacquer/varnish matrix mostly has a refractive index of 1.4 to 1.6. The total system of the frit containing ZnO and the synthetic material matrix or lacquer/varnish matrix appears transparent, if both refractive indices are the same, and appears slightly opaque, if the refractive index of the frit containing ZnO is greater than the refractive index of the surrounding synthetic material matrix. For example, the a and b value change in the CieL*a*b measuring system (yellow blue axis) is changed to a maximum of between −6 and +6 points by incorporating the frit containing ZnO into the synthetic material or lacquer/varnish matrix.

The inventive range of application of the frit containing ZnO includes, for example, thermoplastically deformable synthetic materials, such as PVC, PMMA, ASA, WPC, PP, PE, PS, EVA, PIB, PC and ABS, thermosetting synthetic materials, such as aminoplasts, phenolic plastics, polyurethanes, epoxy resins and polyacrylates, solvent-containing lacquers/varnishes, such as alkyd resin lacquers/varnishes, polyester paints, epoxy resin lacquers/varnishes, polyurethane resin lacquers/varnishes, colors and lacquers/varnishes on the basis of acrylic polymers, polystyrene lacquers/varnishes and polyvinyl resin lacquers/varnishes, water-based lacquers/varnishes, such as dispersion paints, dispersion lacquers/varnishes, groundings and coating agents, radiation-curing lacquer/varnish systems, powder lacquer/varnish systems, paper coatings and other carrier materials based on synthetic and natural polymers or waxes. Moreover, the application in hydraulic-setting construction products, such as joint compounds, cements and plasters, is also included.

The frit containing ZnO may be used alone or in combination with conventional organic or inorganic pigments, and also may be mixed with colorants and fillers as well as with various synthetic material stabilizers or solvents. For example, the frit containing ZnO may be mixed with TiO₂, whereby a UV broadband filter for UVA and UVB radiation can be generated. In this respect, there is no limitation to a specific mixing ratio. In the case of the synthetic material PVC, synthetic material stabilizers are understood as being the additives necessary for the thermoplastic shaping, such as thermostabilizers, softeners, acid scavengers, lubricants and antioxidant agents, whereas fillers refer to calcspar, heavy spar, talcum or kaolin. The polycyclic pigments, such as copper phthalocyanines, quinacridones, pyrrol pyrrols, isoindolines, perylenes and azo pigments, such as diaryl yellow and benzimidazolones, are typical representatives of organic pigments. The most important representatives of inorganic pigments are iron oxides, rutile mixed phase pigments, soot, ultramarines, chromium oxide green as well as a wide range of mixed oxide pigments. Representatives of colorants are, for example, anthrachinons, methines, perinones and anthrapyridones.

In this respect, the frit containing ZnO may be incorporated into the target area of application directly as a powder component or mixed with other materials or as a concentrate in the form of a so-called master batch. A master batch is a premix or (color) concentrate, substantially consisting of 40 wt % to 90 wt % of a pigment or a pigment mixture, and 60 wt % to 10 wt % of a synthetic material mixture and/or a wax mixture or of a solvent, including water and organic solvents.

The application concentration of the frit containing ZnO in the inventive areas of application is, for example, greater than 0.01 wt % and less than 90 wt %, for example between 0.1 wt % and 10 wt %, and, for example between 0.2 wt % and 6 wt %.

The incorporation of the UV absorbing frit containing ZnO as a UV protection additive into dark colored synthetic materials or lacquers/varnishes with an L value of less than 85 points in the CieL*a*b measuring system is recommendable, as the chalking effect otherwise occurring in this case would be visible in a particularly strong way.

The frit containing ZnO is characterized by a low solubility in diluted acids and alkalis. Due to the at least partial incorporation of ZnO into the ceramic network, this characteristic of low solubility in acids and alkalis is maintained even after intensive abrasive mixing. In addition, the frit containing ZnO is resistant to temperatures of up to at least 300° C.

### EXAMPLE

A) Production of the frit containing ZnO

A ZnO containing frit having the following composition:

6.5 wt % K₂O

50.9 wt % ZnO

7.1 wt % Al₂O₃

35.5 wt % SiO₂ is produced by mixing 73.3 g ZnO powder, 55.6 g potassium feldspar powder (K2O*Al₂O₃*6 SiO₂) and 12 g quartz powder (SiO₂) and by subsequent burning/baking at 1,100° C., quenching in a water bath and subsequent grinding in an impact mill to an average grain size diameter of d₅₀<1 μm. The XRD analysis of the frit containing ZnO showed crystalline parts of ZnO.

B) Use of the frit containing ZnO as a UV protection pigment 1 wt % of the frit containing ZnO produced under item A is incorporated together with 2 wt % of a light-fast and weather-resistant dark brown pigment preparation with the following composition:

| | |
|---|---|
| Sicopal brown K 2795 (chromite/ferrochrome brown) | 84.5 wt % |
| PV genuine brown HFR (benzimidazolone) | 8.8 wt % |
| Monarch 800 (carbon black) | 6.7 wt % |

a) into a lead-stearate-stabilized and

b) into a calcium-zinc-stearate-stabilized

PVC window profile formulation

The incorporation occurs by means of rolling the pigment frit PVC mixture for 2 minutes at 180° C. on the calendar roll and by subsequently pressing the rolled sheet to a press plate at 190° C. and with a holding time of 90 seconds.

C) Pigments of comparison

Corresponding to the method under item B, for the purpose of comparison, 1 wt % of each of the following conventional inorganic UV protection pigments is used together with 2 wt % of the dark brown pigment preparation in the different window profile formulations:

1. TiO₂ Kronos 2220

2. TiO₂ Kronos 2057

3. ZnO, quality: white seal

4. ZrSiO₄ 335

5. ZnO containing frit with a ZnO content of 5.6 wt %.

Moreover, 1 wt % of BaSO₄ EWO was used together with 2 wt % of the dark brown pigment preparation in the different window profile formulations as a zero sample.

D) QUV test

With the press plates prepared under items B and C, the so-called QUV test in accordance with DIN EN ISO 4892-3, method A, cycle number 1 was carried out.

In this context, the press plates are alternately irradiated with UV light with the wavelength of 300 nm to 400 nm (maximum irradiation of 340 nm) for 8 hours and exposed to condensed water for 4 hours without irradiation.

After 500 hours already, in the lead-stabilized synthetic material window matrix, the frit containing ZnO according to A shows a significant superiority relative to the other samples. The sample with the frit containing ZnO according to A visually shows no chalking, while all other samples already clearly show chalking After 2,000 hours, chalking is visible in all press plates and synthetic material window matrixes, but the extent of chalking is significantly lower in the sample plate with the frit containing ZnO according to A when compared to all other samples.

The press plates C5, which only had a ZnO content of 5.6 wt % in the frit, showed a considerable/clear degree of chalking, comparable to the samples with the coated TiO₂ according to C1 and C2.

E) Test as to acid stability

4 wt % of the frit containing ZnO produced under item A were added to a calcium-zinc-stabilized PVC window profile formula and rolled on the calendar roll at 180° C., until destruction of the PVC occurs. The same procedure was carried out for a zero sample without a ZnO containing frit and for a sample with 4 wt % of ZnO of the white seal quality. The destruction of the PVC by permanent rolling at 180° C. is, in this experiment, characterized by a separation of the rolled sheet from the hot calendar roll.

Result:

| Sample | Rolling time until PVC is destroyed |
|---|---|
| Zero sample | 38 minutes |
| Frit containing 4 wt % of ZnO | 38 minutes |
| 4 wt % of ZnO white seal | 25 minutes |

The frit containing ZnO acts in an unchanged manner compared to the zero sample. In contrast, the application of pure, unprotected ZnO of the white seal quality accelerates the PVC's degradation.

Further embodiments of the invention are as follows:

According to another embodiment of the invention, the use of a zinc oxide containing frit with a ZnO content of 20 wt % to 75 wt % and an average grain size of less than 30 μm as a UV light absorbing pigment is provided for the areas of application of thermoplastically deformable synthetic materials, solvent-based and water-based and radiation-curing lacquers/varnishes, powder lacquers/varnishes, paper coatings and hydraulic-setting construction products.

In this respect, the frit containing ZnO may, in addition to 20 wt % to 75 wt % of ZnO, further be composed of:
5 wt % to 85 wt % of at least one network former from the oxides of the group of SiO₂, B₂O₃ and P₂O₅,
0.05 wt % to 50 wt % of at least one network modifier from the oxides of the group of BaO, CaO, SrO, K₂O, Na₂O, and Li₂O,
5 wt % to 50 wt % of at least one intermediate oxide from the oxides of the group of Al₂O₃, V₂O₅, Fe₂O₃ and MgO, as well as
0 wt % to 50 wt % of one or more opacifying agents from the oxides of the group of TiO₂, SnO₂ and ZrO₂, CeO₂ as well as Ca₃(PO₄)₂ and Na₃AlF₆.

Alternatively or in addition, the mean grain size may, for example, be less than 5 μm and, for example, less than 1 μm.

Alternatively or in addition, the degree of whiteness measured against air as environmental medium, expressed by the L value in CieL*a*b, may be greater than 90 points when using the frit containing ZnO.

Alternatively or in addition, when using the frit containing ZnO, the frit containing ZnO may be prepared by melting standard oxides, silicates, borates, carbonates or fluorides, such as zinc oxide, feldspars, quartz powder, soda, zirconium silicate, rutile, calcspar, barium carbonate, cryolite, etc. at 600° C. to 1,400° C., by cooling and, as the case may be, by tempering again and by grinding.

Alternatively or in addition, the ZnO may exist in a crystalline form and/or as a component part of the network of the glass phase in the frit, when using the frit containing ZnO.

Alternatively or in addition, the crystalline ZnO of the frit may have a mean/average crystallite size of less than 300 nm and, for example, of less than 100 nm, when using the frit containing ZnO.

When using the frit containing ZnO, the application concentration of the frit containing ZnO may alternatively or in addition be greater than 0.01 wt % and less than 90 wt %, for example between 0.1 wt % and 10 wt %, and for example between 0.2 wt % and 6 wt %, in the inventive areas of application.

When using the frit containing ZnO, the frit containing ZnO may, alternatively or in addition, be used as a UV protection pigment in dark colored synthetic materials or lacquers/varnishes with an L value in the CieL*a*b measuring system of less than 85 points.

Alternatively or in addition, when using the frit containing ZnO, the frit containing ZnO may be used in thermoplastically deformable synthetic materials, such as PVC, PMMA, ASA, WPC, PP, PE, PS, EVA, PIB, PC and ABS, solvent-based lacquers/varnishes, such as alkyd resin lacquers/varnishes, polyester paints, epoxy resin lacquers/varnishes, polyurethane resin lacquers/varnishes, paints and lacquers/varnishes on the basis of acrylic polymers, polystyrene lacquers/varnishes and polyvinyl resin lacquers/varnishes, water-based lacquers/varnishes, such as dispersion paints, dispersion lacquer/varnish paints, groundings and coating agents, radiation-curing lacquer/varnish systems, powder lacquer/varnish systems, paper coatings and other paints based on synthetic and natural polymers, as well as in hydraulic-setting construction products, such as joint compounds, cements and plasters.

According to yet another embodiment of the invention, a zinc oxide containing frit with a ZnO content of 20 wt % to 75 wt % and a mean/average grain size of less than 30 μm may be used as a UV light absorbing pigment for the application areas of thermoplastically deformable synthetic materials, thermosetting synthetic materials, solvent-based lacquers/varnishes, water-based lacquers/varnishes, radiation-curing lacquers/varnishes and lacquer/varnish systems, powder lacquers/varnishes and powder lacquer/varnish systems, other carrier materials on the basis of synthetic and natural polymers or waxes, paper coatings and hydraulic-setting construction products.

In this respect, the frit containing ZnO may, in addition to 20 wt % to 75 wt % of ZnO, further be composed of:
5 wt % to 80 wt % of at least one network former from the oxides of the group of SiO₂, B₂O₃, and P₂O₅,
0.05 wt % to 50 wt % of at least one network modifier from the oxides of the group of BaO, CaO, SrO, K₂O, Na₂O, and Li₂O,
0 wt % to 50 wt % of at least one intermediate oxide from the oxides of the group of Al₂O₃ and MgO, as well as
0 wt % to 50 wt % of one or more opacifying agents from the oxides of the group of TiO₂, SnO₂ and ZrO₂, as well as Ca₃(PO₄)₂ and Na₃AlF₆.

Alternatively or in addition, the mean grain size may, for example, be less than 5 μm and, for example, less than 1 μm, when using the frit containing ZnO.

Alternatively or in addition, the degree of whiteness measured against air as environmental medium, expressed by the L value in the CieL*a*b measuring system, may be greater than 90 points, when using the frit containing ZnO.

Alternatively or in addition, the frit containing ZnO may be prepared by melting customary oxides, silicates, borates, carbonates or fluorides at 600° C. to 1,400° C., by cooling and, as the case may be, by tempering again and by grinding, when using the frit containing ZnO.

Alternatively or in addition, the ZnO may exist in a crystalline form and/or as a component part of the network of the glass phase in the frit, when using the frit containing ZnO.

Alternatively or in addition, the crystalline ZnO of the frit may have a mean crystallite size of less than 300 nm and, for example, of less than 100 nm, when using the frit containing ZnO.

Alternatively or in addition, when using the frit containing ZnO, the application concentration of the frit containing ZnO may be greater than 0.01 wt % and less than 90 wt %, for example between 0.1 wt % and 10 wt %, and, for example, between 0.2 wt % and 6 wt %, in the inventive areas of application.

Alternatively or in addition, when using the frit containing ZnO, the frit containing ZnO may be used as a UV protection pigment in dark colored synthetic materials or lacquers/varnishes with an L value in the CieL*a*b measuring system of less than 85 points.

Alternatively or in addition, the thermoplastically deformable synthetic materials may be PVC, PMMA, ASA, WPC, PP, PE, PS, EVA, PIB, PC and ABS, the thermosetting synthetic materials may be aminoplasts, phenolic plastics, polyurethanes, epoxy resins and polyacrylates, the solvent-containing lacquers/varnishes may be alkyd resin lacquers/varnishes, polyester paints, epoxy resin lacquers/varnishes and polyurethane resin lacquers/varnishes, the paints and lacquers/varnishes may be compounds based on acrylic polymers and polystyrene and polyvinyl resin lacquers/varnishes, the water-based lacquers/varnishes may be dispersion paints, dispersion lacquer/varnish paints, groundings and coating agents, and the hydraulic-setting construction products may be joint compounds, cements and plasters.

Amendments to the claims:

1. se of a frit containing zinc-oxide containing frit with a ZnO content of 20 wt % to 75 wt % as a UV light absorbing UV protection means in PVC, PMMA, ASA, WPC, PP, PE, PS, EVA, PIB, PC or ABS.

2. Use of a frit containing ZnO according to claim 1, characterized in that the frit containing ZnO is, in addition to 20 wt % to 75 wt % of ZnO, further composed of:
5 wt % to 80 wt % of at least one network former from the oxides of the group of SiO₂, B₂O₃ and P₂O₅,
0.05 wt % to 50 wt % of at least one network modifier from the oxides of the group of BaO, CaO, SrO, K₂O, Na₂O and Li₂O,
0 wt % to 50 wt %, for example 5 wt % to 50 wt %, of at least one intermediate oxide from the oxides of the group of Al₂O₃, V₂O₅, Fe₂O₃ and MgO, as well as
0 wt % to 50 wt % of one or more opacifying agents from the oxides of the group of TiO₂, SnO₂ and ZrO₂, CeO₂ as well as Ca₃(PO₄)₂ and Na₃AlF₆.

3. Use of a frit containing ZnO according to claim 2, characterized in that the average grain size of the zinc oxide containing frit, related to the particle number, is less than 30 μm, for example less than 5 μm, for example less than 1 μm.

4. Use of a frit containing ZnO according to claim 3, characterized in that the degree of whiteness of the frit measured against air as environmental medium, expressed by the L value in the CieL*a*b measuring system, is greater than 90 points.

5. Use of a frit containing ZnO according to claim 4, characterized in that the frit containing ZnO is prepared by melting commercially available oxides, silicates, borates, carbonates or fluorides, such as zinc oxide, feldspars, quartz powder, soda, zirconium silicate, rutile, calcspar, barium carbonate, cryolite etc., at 600° C. to 1,400° C., by cooling, by optionally tempering again, and by grinding.

6. Use of a frit containing ZnO according to claim 5, characterized in that the ZnO is provided in a crystalline form and/or as a component part of the network of the glass phase in the frit.

7. Use of a frit containing ZnO according to claim 6, characterized in that the crystalline ZnO of the frit has an average crystallite size of less than 300 nm, for example of less than 100 nm.

8. Use of a frit containing ZnO according to claim 7, characterized in that the application concentration of the frit containing ZnO in the carrier material is greater than 0.01 wt % and less than 90 wt %, for example between 0.1 wt % and 10 wt %, for example between 0.2 wt % and 6 wt %.

9. Use of a frit containing ZnO according to claim 8, characterized in that the frit containing ZnO is used as a UV protection means in a dark colored synthetic material with an L value in the CieL*a*b measuring system of less than 85 points.

10. (canceled)

11. Use of a frit containing ZnO according to claim 9, characterized in that the ZnO concentration in the frit is greater than 30 wt %, for example greater than 50 wt %.

12. PVC synthetic material, into which a zinc-oxide containing frit with a ZnO content of 20 wt % to 75 wt % is incorporated as a UV light absorbing UV protection means.

13. PVC synthetic material according to claim 12, wherein the concentration of the frit containing ZnO is greater than 0.01 wt % and less than 90 wt %, for example between 0.1 wt % and 10 wt %, for example between 0.2 wt % and 6 wt %.

14. PVC synthetic material according to claim 12, wherein the average grain size of the frit containing ZnO, in relation to the particle number, is less than 30 μm, for example less than 5 μm, for example less than 1 μm.

15. PVC synthetic material according to claim 14, wherein the degree of whiteness of the frit, measured against air as environmental medium, expressed by the L value in the CieL*a*b measuring system, is greater than 90 points.

16. PVC synthetic material according to claim 15, wherein the PVC synthetic material has an L value in the CieL*a*b measuring system of less than 85 points.

17. PVC synthetic material according to any of claim 16, wherein the ZnO is provided in a crystalline form and/or as a component part of the network of the glass phase in the frit.

18. PVC synthetic material according to claim 17, wherein the crystalline ZnO of the frit has an average crystallite size of less than 300 nm, for example of less than 100 nm.

19. PVC synthetic material according to claim 18, wherein the ZnO concentration in the frit is greater than 30 wt %, for example greater than 50 wt %.
